(19) United States
(12) Patent Application Publication
(10) Pub. No.: US 2013/0147809 A1
(43) Pub. Date: Jun. 13, 2013

(54) METHOD AND APPARATUS FOR CALLIGRAPHIC BEAUTIFICATION OF HANDWRITTEN CHARACTERS

(71) Applicant: Samsung Electronics Co., Ltd., Suwon-si (KR)

(72) Inventors: Zhenbo LUO, Beijing (CN); Youxin CHEN, Beijing (CN); Yan WANG, Beijing (CN); Sang-Ho KIM, Beijing (CN)

(73) Assignee: Samsung Electronics Co., Ltd., Suwon-si (KR)

(21) Appl. No.: 13/711,026

(22) Filed: Dec. 11, 2012

(30) Foreign Application Priority Data
Dec. 12, 2011 (CN) 201110412817.6

(51) Int. Cl. G09G 5/28

(52) U.S. Cl. CPC G09G 5/28
USPC 345/472.3

(57) ABSTRACT

A method and an apparatus for calligraphic beautification of handwritten characters are provided. The method includes collecting handwriting data of a user's handwritten input in real-time, determining whether a calligraphic beautification operation is to be started, determining stroke structure information of a stroke according to the collected handwriting data if the beautification operation is to be started, continuing the collecting of the handwriting data if the calligraphic beautification operation is not to be started, performing the calligraphic beautification operation according to a calligraphic beautification method corresponding to the stroke structure information, and displaying a beautified result.

### PRIORITY

This application claims the benefit under 35 U.S.C. §119(a) of a Chinese patent application filed on Dec. 12, 2011 in the Chinese Intellectual Property Office and assigned Serial No. 201110412817.6, the entire disclosure of which is hereby incorporated by reference.

### BACKGROUND OF THE INVENTION

1. Field of the Invention

The present invention relates to inputting techniques. More particularly, the present invention relates to a method and an apparatus for calligraphic beautification of handwritten characters.

2. Description of the Related Art

Compared with keyboard input, handwritten input may provide merits for a user, such as being intuitive, convenient and user-friendly. With the development and popularization of digital devices and touch-screen techniques, handwritten input is increasingly used in various kinds of inputting devices such as mobile phones, tablet Personal Computers, electronic writing boards, intelligent televisions, and any other similar electronic device that may receive handwritten input. The inputting device collects handwriting data of the user's input, such as X-axis coordinates and Y-axis coordinates. However, if a trajectory constructed by the handwriting data is displayed directly, strokes corresponding to the handwriting data may look very blunt without displaying any aesthetic qualities, which may result in a bad user experience.

In order to improve the user's experience, some calligraphic beautification methods of handwritten characters provided in recent years. For example, there are calligraphic beautification methods based on recognizing a result and template merging, methods based on templates, methods based on handwriting transformation and methods based on stroke rendering, as well as other similar methods.

However, when a calligraphic beautification method is adopted, the same beautification style, form and/or process may be used for the same stroke or strokes of the same type, without consideration of impact between strokes. Thus, calligraphic individualities of human beings may not be reflected. For example, Chinese character “san” (“ [symbol] ”) has three same horizontal strokes. Existing calligraphic beautification methods may beautify the three strokes to the same contour. However, considering the distribution of the three strokes, the user may write the second stroke relatively light and short but write the third stroke relatively heavy and long. Thus, a result of a calligraphic beautification method applied to the three strokes should not be the same. In the existing beautification methods, the user's calligraphic individuality cannot be reflected.

Therefore, a need exists for a system and method for a method and an apparatus for calligraphic beautification of handwritten characters that reflects a user's calligraphic individuality.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for calligraphic beautification of handwritten characters, so as to make full use of stroke structure information and reflect user's calligraphy individuality.

According to an aspect of the present invention, a method for calligraphic beautification of handwritten characters is provided. The method includes collecting handwriting data of a user's handwritten input in real-time, determining whether a calligraphic beautification operation is to be started, determining stroke structure information of a stroke according to the collected handwriting data if the beautification operation is to be started, continuing the collecting of the handwriting data if the calligraphic beautification operation is not to be started, performing the calligraphic beautification operation according to a calligraphic beautification method corresponding to the stroke structure information, and displaying a beautified result.

According to another aspect of the present invention, an apparatus for calligraphic beautification of handwritten characters is provided. The apparatus includes a handwritten input unit for collecting handwriting data of a user's input in real-time, a determining unit for determining whether to start the beautification operation, a stroke structure analyzing unit that is started by the determining unit if it is determined to start the beautification operation, the stroke structure analyzing unit being for determining the stroke structure information according to the collected handwriting data, and a beautifying unit, the beautifying unit being for performing the beautification operation according to a predefined handwriting beautification method corresponding to the stroke structure information and for obtaining a beautified result, and a displaying unit for displaying the beautified result.

In the method and apparatus for calligraphic beautification of handwritten characters provided by the present invention, since the stroke structure information is fully-used during the beautification procedure, the stroke structure information is associated with different beautification methods. Thus, the beautified result conforms to user's handwriting habit better and a real experience is provided.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart of a method according to an exemplary embodiment of the present invention;

FIG. 2 is a flowchart illustrating a method according to an exemplary embodiment of the present invention;

FIG. 3 is a schematic diagram illustrating a structure of an apparatus according to an exemplary embodiment of the present invention;

FIG. 4 is a schematic diagram illustrating a first example effect according to an exemplary embodiment of the present invention;

FIG. 5 is a schematic diagram illustrating a second example effect according to an exemplary embodiment of the present invention; and

FIG. 6 is a schematic diagram illustrating a third example effect according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention may determine and use different beautification methods according to stroke structure information, so as to make the beautified result more conforming to a user's handwriting habit.

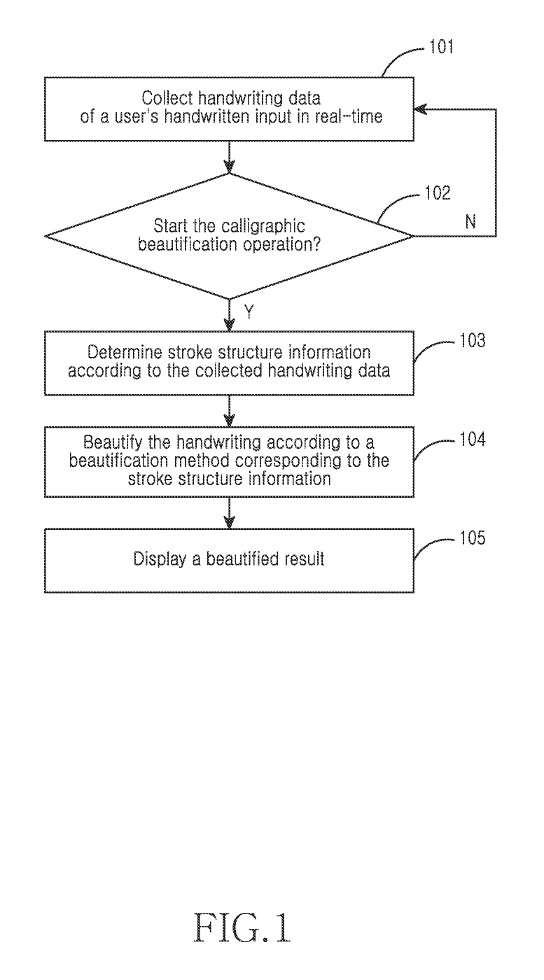

FIG. 1 is a flowchart illustrating a method for calligraphic beautification of handwritten characters according to an exemplary embodiment of the present invention.

Referring to FIG. 1, the method includes operation 101 so that handwriting data of a user's handwritten input is collected in real-time. Herein, the handwriting data may include X-axis coordinates and Y-axis coordinates, or may be any other form of data, such as vectors, image data, or any other suitable and/or similar form of data based on the user's handwritten input. The handwriting data may include other information, such as pressure information, speed information, and any other similar and/or suitable information based on the user's handwritten input. Next, in operation 102, it may be determined whether to start the calligraphic beautification operation. If it is determined to start the calligraphic beautification operation, then operation 103 is performed, otherwise, the method returns to operation 101 in order to continue collecting the handwriting data.

A time for starting the calligraphic beautification operation may be variable, which will be shown in the following exemplary embodiments. In operation 103, stroke structure information may be determined according to the collected handwriting data. Herein, the stroke structure information may refer to a structure relationship between a certain stroke and other strokes. The stroke structure information may include information on at least one of whether the stroke is an important stroke, whether the stroke has an adjacent stroke at the end of the stroke, whether the stroke is in a surrounded structure, and other similar and/or suitable information.

Although three kinds of stroke structure information are mentioned above, the present invention is not limited thereto, and there may be other kinds of information such as stroke structure information including which part of an up-down structure the stroke is in, which part of a left-right structure the stroke is in, which part of an up-middle-down structure the stroke is in, which part of a left-middle-right structure the stroke is in, which part of a Chinese Pin (“ [symbol] ”) structure the stroke is in, and other similar and/or suitable stroke information and stroke structure information. Any structure capable of reflecting the relationship of strokes may be included with the present exemplary embodiments of the present invention. The present exemplary embodiments are not restricted to the above examples. Thus, the determination of the stroke structure information according to the handwriting data will be described in detail in the exemplary embodiments described below.

In operation 104, the handwriting is beautified according to the calligraphic beautification method corresponding to the stroke structure information. For different kinds of stroke structure information, the beautification method may be different. The calligraphic beautification method may include two phases, those being a skeleton modeling and a contour modeling. First, the skeleton modeling is performed using the collected handwriting data according to a predefined method corresponding to the stroke structure data. Then, based on the skeleton modeling, contour modeling is performed according to the predefined beautification method corresponding to the stroke structure information.

After the beautification operation of operation 104, then in operation 105, the beautified result is displayed by rendering, i.e. displaying, an area of a closed contour obtained by the beautification. The detailed method will be described in the following exemplary embodiments.

Another exemplary embodiment will be described below. In this exemplary embodiment, there is a case where the handwriting data includes X-axis coordinates, Y-axis coordinates and pressure information, and the stroke structure information includes whether the stroke is an important stroke, whether the stroke has an adjacent stroke at the end of the stroke and whether the stroke is in a surrounded structure.

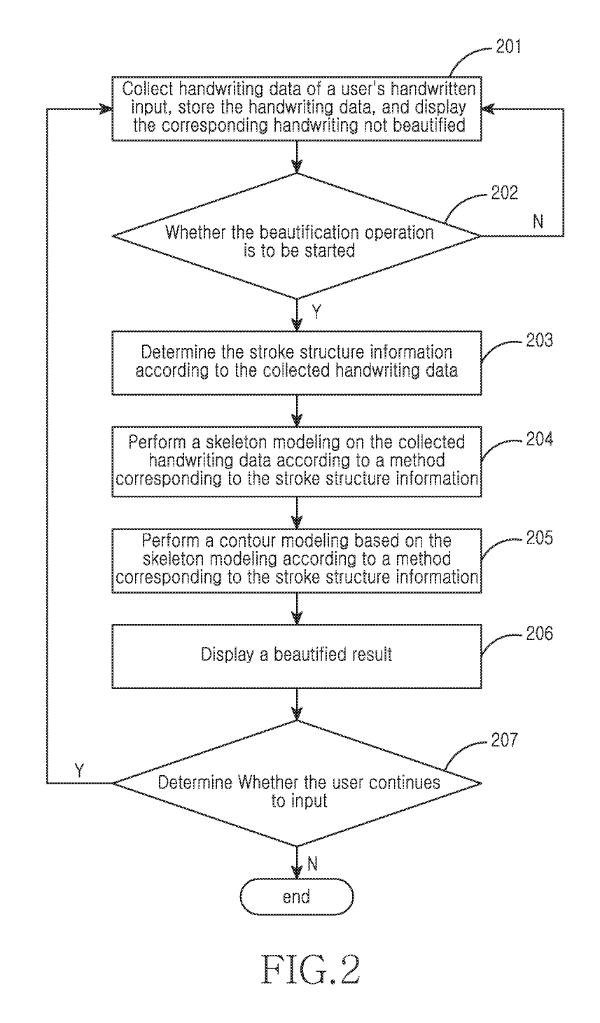

FIG. 2 is a flowchart illustrating a method according to an exemplary embodiment of the present invention.

In operation 201, handwriting data of a user's handwritten input is collected and stored, and the corresponding handwriting is displayed before being beautified. The handwriting data that is collected and stored may include X-axis coordinates, Y-axis coordinates and pressure information. In this exemplary embodiment, the corresponding handwriting that is displayed before being beautified may be displayed immediately after the user inputs the handwriting so as to provide a real-time display of the corresponding handwriting to the user providing the handwritten input. However, the present invention is not limited thereto, and in operation 201, the corresponding handwriting may be not displayed before being beautified.

In addition, the displaying of the handwriting corresponding to the handwriting data may be displayed using only the X-axis coordinates and the Y-axis coordinates. Accordingly, the pressure information may be used as a basis for determining whether the stroke is an important stroke, which is not described in detail herein. Next, in operation 202, it is determined whether to start the beautification operation, and if it is determined to start the beautification operation then operation 203 is performed, otherwise, operation 201 is performed again.

A time for starting the beautification operation may be determined according to a plurality of conditions, including at least one of the following. For example, the time for starting the beautification operation may be determined according to whether the current stroke is ended, and if the current stroke is ended, start the beautification operation. Also, the time for starting the beautification operation may be determined according to the collected handwriting data and whether the number of handwriting points of the current stroke, which may indicate a length of a stroke, exceeds a predefined threshold, wherein, if yes, the beautification operation is started. Accordingly, if the length of a stroke is long, the beautification operation may be performed before the stroke is ended in order to provide a real-time beautification operation to the user. Also, if the operating time of the current stroke is long, then the beautification operation may be performed before the stroke is ended in order to provide the real-time beatification operation to the user. Additionally, the time for starting the beautification operation may be determined according to whether an interval between a current time and a time at which the beautification operation was started last time is larger than a predefined time threshold, and, if yes, the beautification operation may be started.

However, the present invention is not limited thereto, and the beautification operation may be started by other manners, such as configuring a fixed interval, starting the beautification operation periodically according to the fixed interval, or any other similar and/or suitable manner of starting the calligraphic beautification operation.

In operation 203, stroke structure information of the stroke is determined according to the collected handwriting data. Operation 203 may be executed according to two aspects, those being “which kind of stroke structure information is determined according to which handwriting data” and “the detailed manner for determining the stroke structure information”. In operation 203, the handwriting data may be handwriting data corresponding to all strokes or handwriting data corresponding to some strokes. Thus, the stroke structure information determined may be corresponding to all the strokes or corresponding to some of the strokes. According to the above analysis, when the stroke structure information is determined in operation 203, there may be three cases, which are described below.

According to a first case, the stroke structure information of all strokes may be obtained according to the collected handwriting data of all strokes, and all existing stroke structure information may be updated. In other words, since each stroke always has a relationship with another existing stroke, if all the strokes are considered, then he stroke structure information of each stroke may be determined accurately. Therefore, each time the user inputs a new stroke, the stroke structure information of all existing strokes may be determined according to all the existing handwriting data.

According to a second case, the stroke structure information of some of the strokes may be obtained according to the collected handwriting data of all strokes, and the stroke structure information of some of the existing strokes may be updated. In other words, each time the user inputs a new stroke, all the handwriting data may be considered, but only the stroke structure information of some of the strokes (e.g., strokes that are adjacent to the current stroke and the current stroke) may be updated. Thus, a speed for determining the stroke structure information in operation 203 may be increased.

According to a third case, the stroke structure information of some of the strokes may be obtained according to the collected handwriting data of some of the strokes, and the stroke structure information of some of the strokes may be updated. In other words, in the third case, each time the user inputs a new stroke, not all handwriting data will be considered. Rather, only the handwriting data of some of the strokes (e.g., the current stroke and strokes that are adjacent to the current stroke) will be considered, and only the stroke structure information of some of the strokes (e.g., the current stroke and the strokes that are adjacent to the current stroke) will be updated. Thus, the speed for determining the stroke structure information in operation 203 may be increased.

Whichever case is selected, the stroke structure information may be determined according to the collected handwriting data. The detailed implementation of determining the stroke structure information will be given below, wherein three kinds of stroke structure information, that being “whether the stroke is an important stroke”, “whether the stroke has an adjacent stroke” and “whether the stroke is in a surrounded structure”, are taken as an example.

With respect to the first kind of stroke structure information, when determining whether a stroke is an important stroke, the length of the stroke may be determined according to the collected handwriting data, and an average length of strokes may be determined according to the handwriting data of all strokes or some of the strokes. The length of the stroke may be compared with the average length. If the length of the stroke is larger than the average length, then the stroke is determined to be an important stroke, otherwise, the stroke is determined to be an unimportant stroke. There are many methods for determining the length of the stroke according to the handwriting data. For example, the number of handwriting points from the beginning of the stroke to the end of the stroke may be calculated, wherein the number of handwriting points may be taken as the length of the stroke. It is also possible to configure a lower limit threshold for the length of the stroke, wherein if the length of a current stroke is smaller than the threshold, the stroke may be determined to be a short stroke. Furthermore, a beautification method corresponding to the short stroke may be adopted in the following. In addition, when the length of the stroke is determined, it may be possible to define that the average length is calculated if the length of the stroke is larger than a predefined length and that the average length is not calculated otherwise.

The determination of whether a stroke is an important stroke may also be may also be made by determining a pressure distribution of the stroke according to the pressure information in the handwriting data. A stroke with a higher average pressure may be determined to be an important stroke and a stroke with a low average pressure may be determined to be an unimportant stroke. In the present exemplary embodiment, the handwriting data may include the X-axis coordinates, Y-axis coordinates, and also the pressure information. The handwriting data may include the pressure information because when the user writes, pressures of different parts of the same stroke may be different. For example, when writing Chinese character “Yi” which is written as “ [symbol] ”, the user may write heavier, i.e., with a high pressure, at the beginning of the stroke, i.e. in the head of the stroke, and write lightly, i.e., with a low pressure, at the end of the stroke, such as in the tail of the stroke. Therefore, through analyzing the pressure information, a stroke with a high average pressure may be determined to be an important stroke, and a stroke with a low average pressure may be determined to be an unimportant stroke.

With respect to the second kind of stroke information, when it is determined that the stroke has an adjacent stroke, then a distance between the end of the stroke and other strokes may be calculated according to the handwriting data of the stroke. If the distance is smaller than a predefined distance threshold, then it may be determined that there is an adjacent stroke at the end of the stroke. Otherwise, it may be determined that there is no adjacent stroke. That is to say, in this exemplary embodiment, different beautification methods may be adopted based on whether there is an adjacent stroke at the two ends of the stroke. Accordingly, when the user writes, if there is no adjacent stroke at one end of the stroke, the stroke may be written in a plump manner, and otherwise, the stroke may be written in a compact manner. For example, when a left-falling stroke, which is written as “ [symbol] ”, in Chinese character “Ren”, which is written as “ [symbol] ”, is written, then there may be no adjacent stroke in the head of the stroke, and thus, this stroke is usually written in the plump manner. However, when the left-falling stroke in Chinese character “ [symbol] ” is written, since there is an adjacent stroke in the head of the stroke, this stroke is usually written in the compact manner. For another example, there is no adjacent stroke at two ends of the vertical stroke of Chinese character “Zhong”, which is written as “ [symbol] ”, whereas there is an adjacent stroke at each end of the vertical stroke of Chinese character “Wang”, which is written as “ [symbol] ”. Thus, even if the input trajectories inputted by the user are the same, different beautification methods may be adopted in order to write the vertical stroke in Chinese character “Zhong” “ [symbol] ” in the plump manner and in order to write the vertical stroke in Chinese character “Wang” “ [symbol] ” in the compact manner.

With respect to the third kind of stroke information, when it is determined that a stroke is in a surrounded structure, it may be possible to determine whether the stroke is located in a rectangle formed by at least one other stroke according to the handwriting data of the stroke. Accordingly, it may be determined that the stroke is in a surrounded structure, and otherwise, it may be determined that the stroke is not in a surrounded structure. In other words, in the present exemplary embodiment, the same stroke or strokes may be beautified by different beautification methods due to the fact that the strokes may be in the surrounded structure, e.g., a whole surrounded structure or a half surrounded structure. Accordingly, when the user writes, if a stroke is in a surrounded structure, then the user may write the stroke in the compact manner, and otherwise, the user may write the stroke in the plump manner. For example, when the strokes of “Yu”, which are written as “ [symbol] ”, in Chinese character “Guo”, which is written as “ [symbol] ”, are written, since the strokes of “Yu” are in the surrounded structure, then the strokes are usually written in the compact manner. However, when the strokes of “Yu” “ [symbol] ” are written without the surrounded structure, then the strokes are usually written in the plump manner.

It should be noted that the meaning of “located in the rectangle formed by at least one other stroke” does not mean that the other stroke has to form a standard rectangle. On the contrary, in the present exemplary embodiments, it may mean that the handwriting data, such as the X-axis coordinates and Y-axis coordinates, of the current stroke is within the range of the handwriting data of at least one other stroke. For example, in a case where the handwriting data of a current stroke is {(5, 5), (6, 5), (7, 6), (8, 6), (9, 7)}, then the minimum X-axis coordinate of the current stroke is 5 and the maximum X-axis coordinate of the current stroke is 9. The minimum Y-axis coordinate of the current stroke is 5 and the maximum Y-axis coordinate of the current stroke is 7. If, in the handwriting data of another stroke, the minimum X-axis coordinate is 2, the maximum X-axis coordinate is 15, the minimum Y-axis coordinate is 2 and the maximum Y-axis coordinate is 10, then the coordinates of the handwriting data of the current stroke fall within the range of the handwriting data of the other stroke. Therefore, it is determined that the current stroke is in the surrounded structure.

Next, in operation 204, the skeleton modeling is performed on the handwriting data collected according to a method corresponding to the stroke structure information. The skeleton modeling methods may include a first operation of interpolating or sub-sampling the handwriting data collected according to a recognizing ratio of the device, a second operation of performing transformation operations such as smoothing, rotating, expanding, contracting and translating on the handwriting data after being interpolated or sub-sampled, a third operation performing a segmentation operation on the skeleton according to the handwriting data after the transformation operation; and a forth operation of determining a skeleton type and/or position information according to the skeleton after the segmentation operation.

In particular, as to the first operation, a pixel distance Dpi, which corresponds to a physical distance, may be calculated according to the recognizing ratio of the device, wherein Dpi>0. If the pixel distance between adjacent points in the handwriting data of the user's input is larger than Minterp times of Dpi, wherein Minterp>0, then at least one of linear interpolation, polynomial interpolation and spline interpolation methods may be adopted in order to insert handwriting points until the pixel distance between adjacent points in the handwriting data is not larger than Minterp times of Dpi. If the pixel distance between adjacent points in the handwriting data of the user is smaller than Mresample times of Dpi, wherein Mresample>0, then at least one of equal pixel distance, equal sample number and random selection methods may be adopted to remove handwriting points from the handwriting data of the user until the pixel distance between adjacent points is larger than Mresample times of Dpi.

As to the second operation, the smoothing of the current handwriting point may be performed according to at least one of an average value of Nsmooth adjacent points in the same stroke and adjacent strokes via at least one of a rectangle wave, a triangle wave and a pulse wave manner, wherein Nsmooth>0. The rotating of the handwriting data may be performed through calculating a geometrical center of the stroke and rotating the stroke clockwise for a number of degrees, those being Ascroll degrees, taking the geometrical center as a center, wherein −180°<Ascroll<180°. The expanding and contracting of the handwriting data may be performed using several different operations. For example, calculating the length Lstroke of the stroke, wherein Lstroke>0, and calculating a prolonged pixel distance Lplus or a shortened pixel distance Lsub according to a beautification parameter, wherein Lplus>0, Lsub>0 and Lsub<Lstroke/2. Also, if it is desired to expand the stroke, handwriting points may be inserted along a tangential direction with a length of Lplus at the beginning point and/or the end point of the stroke. On the other hand, if it is desired to shorten the stroke, handwriting points with an arc length of Lsub may be removed according to the handwriting information of the user at the beginning point and/or end point of the stroke. The translating of the handwriting data may be performed through at least one of calculating the geometrical center of the stroke while also calculating a distance between X-axis coordinate of the handwriting point and that of the geometrical center, and translating the Y-axis coordinate of the handwriting point with a distance of Mscroll times of the distance of the X-axis coordinate, wherein Mscroll>0.

As to the third operation, multiple segments of the skeleton may be obtained according to the handwriting information of the user. A curvature may be calculated according to the handwriting information of the user, and if the curvature is larger than C, then the skeleton is segmented at the handwriting point, wherein C>0.

As to the fourth operation, the type of the skeleton may be determined according to basic components of a character set, e.g., strokes. For example, if the character set is Chinese, the type of the skeleton may be a horizontal stroke, a vertical stroke, a left-falling stroke, a right-falling stroke, a raising stroke, a hook stroke and a dot stroke. If the character set is Korean, the type of the skeleton may be a horizontal stroke, a vertical stroke, a left-falling stroke, a right-falling stroke, a raising stroke, a hook stroke, a dot stroke and an arc stroke. If the character set is English, the type of the skeleton may be a C-shape arc, an S-shape arc or straight line. However, the present invention is not limited there to, and any character set of any language may include any suitable stroke in the type of skeleton. Thus, when the type of skeleton of a stroke is determined, a vector may be formed by the beginning point and the end point of the skeleton, and the type information of the skeleton may be obtained according to the length and/or direction of the vector. In the case of Chinese as an example character set, if the length of the vector is smaller than Lmin, wherein Lmin>0, then the type of the skeleton is dot stroke. However, if the length of the stroke is larger than Lmin and an angle between the vector and X-axis is smaller than A1, then the type of the skeleton is horizontal stroke, wherein A1>0. Furthermore, if the length of the vector is larger than Lmin and the angle between the vector and the Y-axis is smaller than A2, then the type of the skeleton is vertical stroke, wherein A2>0. On the other hand, if the length of the vector is larger than Lmin and the direction is larger than A31 but smaller than A32, then the type of the skeleton is left-falling stroke, wherein 180°<A31, A32<270°, and A32>A31. Additionally, if the length of the vector is larger than Lmin and the direction is larger than A41 but smaller than A42, then the type of the skeleton is right-falling stroke, wherein 270°<A41, A42<360°, wherein A42>A41. If the length of the vector is larger than Lmin and the direction is larger than A51 but smaller than A52, then the type of the skeleton is raising stroke, wherein 0°<A51, A52<90°, and A52>A51. Also, if the length of the vector is larger than Lmin and the direction is larger than A61 but smaller than A62, then the type of the skeleton is hook stroke, wherein 90°<A61, A62<180°, and A62>A61.

The position information of the skeleton may be determined according to a position of an end point of the skeleton in the stroke before segmentation. For example, a skeleton is a free skeleton when the skeleton is a complete stroke. If a beginning point of the stroke is a beginning point of a stroke and the end point of the skeleton is a middle handwriting point of the stroke, then the position of the skeleton is at a head. If the beginning point of the skeleton is the middle handwriting point of the stroke and the end point of the skeleton is the end point of the stroke, then the position of the skeleton is at a tail. If the beginning point and the end point of the skeleton are both middle points of the stroke, then the position of the skeleton is at a middle.

In operation 205, based on the skeleton modeling, contour modeling may be performed by adopting a method corresponding to the stroke structure information in order to obtain a beautification result. The contour modeling may be performed according to the following methods: calculating a tangent vector direction and/or a normal vector direction of the skeleton, calculating a basic contour surrounding the skeleton according to the tangent vector direction and/or normal vector direction, the type of the skeleton and/or position information, wherein the basic contour consists of spline curves or straight lines, calculating a calligraphic head contour at the end point of the skeleton, wherein the head contour consists of spline curves or straight lines, calculating a connection contour between skeletons, wherein the connection contour consists of spline curves and straight lines, re-sorting the basic contour, the head contour and/or the connection contour of the stroke to obtain a closed contour formed by the basic contour, the head contour and the connection contour being end to end, wherein the closed contour consists of spline curves and straight lines.

In other words, in order to achieve a beautified effect, a monotonous handwriting may be changed to a closed contour with a certain width. The closed contour consists of spline curves and straight lines. With respect to the different beautification methods adopted, the closed contour may be described by different numbers of spline curves or straight lines. A greater the number of the spline curves results in a greater number of the calligraphic styles of the closed contour.

In addition, in the present exemplary embodiment, different contour expression methods may be adopted with respect to different kinds of stroke structure information, so as to conform to the user's habit. Therefore, a correspondence between a kind of stroke structure information and a contour is important. Thereafter, analysis is given with respect to three kinds of stroke structure information “whether the stroke is an important stroke”, “whether the stroke has an adjacent stroke” and “whether the stroke is in a surrounded structure”.

With respect to the first kind of stroke information, if the stroke structure information shows that the stroke is an important stroke, then the closed contour is obtained by contour modeling of more than N1 spline curves, wherein N1 is an integer larger than 0. However, if the stroke structure information shows that the stroke is an unimportant stroke, then the closed contour is obtained by contour modeling of less than M1 spline curves, wherein M1 is an integer larger than 0 but smaller than or equal to N1.

With respect to the second kind of stroke information, if the stroke structure information shows that the stroke has no adjacent stroke at the end of the stroke, then the closed contour is obtained by contour modeling of more than N2 spline curves, wherein N2 is an integer larger than 0. However, if the stroke structure information shows that the stroke has an adjacent stroke at the end of the stroke, then the closed contour is obtained by contour modeling of less than M2 spline curves, wherein M2 is larger than 0 but smaller than or equal to N2.

With respect to the third kind of stroke information, if the stroke structure information shows that the stroke is not in a surrounded structure, then the closed contour is obtained by contour modeling of more than N3 spline curves, wherein N3 is an integer larger than 0. However, if the stroke structure information shows that the stroke is in a surrounded structure, then the closed contour is obtained by contour modeling of less than M3 spline curves, wherein M3 is an integer larger than 0 but smaller than or equal to N3.

In other words, the criteria in the present exemplary embodiment may include that the contour of an important stroke is created using more spline curves than that of an unimportant stroke, that the contour of a stroke having no adjacent stroke is created using more spline curves than that of a stroke with an adjacent stroke, and that the contour of a stroke not in a surrounded structure is created using more spline curves than that of a stroke in a surrounded structure. However, the present invention is not limited thereto, and other similar and/or suitable criteria may also be adopted.

In some cases, if one stroke matches more than one of the above characteristics, then a conflict may be generated when determining which contour should be adopted. For example, a stroke may be an important stroke and may be in a surrounded structure at the same time. If the stroke is processed according to the criteria of important stroke, then the contour of the stroke should be created using relatively more spline curves and the contour should be of the plump manner. If the stroke is processed according to the criteria of surrounded structure, then the contour of the stroke should be created using relatively less spline curves and the contour should be the compact manner. At such a time, there may be a conflict for selecting the contour.

In this case, where there is a conflict for selecting the contour, a priority order may be used. In other words, if the stroke structure information includes whether the stroke is an important stroke, whether the stroke has an adjacent stroke and whether the stroke is in a surrounded stroke, then priorities may be configured. For example, a highest priority may correspond to information of whether the stroke is in a surrounded structure, a high priority may correspond to the information of whether the stroke has an adjacent stroke, and a lowest priority may correspond to the information of whether the stroke is an important stroke. Thus, during the contour modeling, the closed contour may be determined according to the priorities.

If the stroke is in a surrounded structure, then the closed contour (e.g., a compact contour) corresponding to the case that the stroke is in a surrounded structure is adopted. If the stroke is not in a surrounded structure, but has an adjacent stroke at the end of the stroke, then the closed contour (e.g., a compact contour) corresponding to the case that the stroke has an adjacent stroke at the end of the stroke is adopted. If the stroke is not in a surrounded structure and has no adjacent stroke at the end of the stroke and is an important stroke, then the closed contour (e.g., a plump contour) corresponding to the case that the stroke is an important stroke is adopted. If the stroke is not in a surrounded structure and has no adjacent stroke at the end of the stroke and is an unimportant stroke, a default closed contour (e.g., a compact contour) may be adopted.

The case of the conflict that a stroke is an important stroke and is in a surrounded structure is still taken as an example in the following. Since priorities are configured, the priority of whether the stroke is in the surrounded structure is higher than that of whether the stroke is an important stroke, it should be determined first that whether the stroke is in the surrounded structure. In this case, since a compact contour should be adopted for the stroke in the surrounded structure, the compact contour will be adopted directly using relatively less spline curves when there is conflict. In operation 206, a beautified result is displayed.

In the present exemplary embodiment, the handwriting without being beautified may be displayed when the user inputs the handwriting, and a beautified result of other strokes may be displayed before the beautification operation is started for the current stroke, and the input of the current stroke may have effect to the stroke structure information of all or some of the existing strokes. Therefore, the displaying of this step may include the following cases.

In a first case, clearing up the handwriting which is not beautified and is displayed before the beautification operation is started and clearing up all the beautified result, rendering and displaying all the beautified result obtained after the beautification operation is started. In other words, suppose the handwriting without being beautified has been displayed and a beautified result of other strokes has been displayed. Since the input of the current stroke updates the stroke structure information of all the other strokes, the beautified result of the other strokes may have changed. Therefore, in this operation, the handwriting which is not beautified and the beautified result of all the other strokes may need to be cleared up, and a display according to the beautified result of all the strokes may be rendered.

In a second case, clearing up the handwriting which is not beautified and is displayed before the beautification operation is started and part of the beautification result, and rendering and displaying the part of the beautified result obtained after the beautification operation is started. In other words, suppose the handwriting not to be beautified has been displayed and beautified result of other strokes having been displayed. Since the input of the current stroke updates the stroke structure information of some of the other strokes (e.g., adjacent strokes of the current stroke), then the beautified result of some of the other strokes may change. Therefore, in this operation, the handwriting not to be beautified and the beautified result of some other strokes may need to be cleared up, and a display according to the updated beautified result of the strokes may be rendered.

In addition, when a closed contour is rendered, depth information of the closed contour may be obtained by calculating according to the stroke structure information and/or handwriting data. With respect to different kinds of depth information, different three-dimensional rendering algorithms may be adopted to render the closed contour with the depth information. Alternatively, a shape at the edge of the closed contour may be calculated according to the stroke structure information and/or handwriting data. Different rendering algorithms may be adopted for an area inside the closed contour and/or the shape of the edge, so as to have a three-dimensional effect.

The depth information of the closed contour may be calculated according to the following: configuring a depth value of a center area of the closed contour to a relatively large value, configuring a depth value of an edge area of the closed contour to a relatively small value, configuring the depth value of an important stroke to a relatively large value while configuring the depth value of an unimportant stroke to a relatively small value, configuring the depth value of the end of a stroke having an adjacent stroke to a relatively small value while configuring the depth value of the end of a stroke without an adjacent stroke to a relatively large value, configuring the depth value of a stroke in a surrounded structure to a relatively small value while configuring the depth value of a stroke not in the surrounded structure to a relatively large value. However, the present invention is not limited thereto, and the depth information may be calculated according to any other similar and/or suitable methods, e.g. adopting the same depth information for the inside of the closed contour.

In operation 207, it is determined whether the user continues to input handwritten inputs, and if yes, operation 201 is repeated and otherwise, the procedure ends.

In the present exemplary embodiment, a circulation manner is adopted to detect the user's input in real-time. The detection of the input and the collecting of the handwriting data may be processed in parallel with the following beautification operation, and other manners other than the circulation manner may be adopted.

In accordance with the above method for calligraphic beautification of handwritten characters, an exemplary embodiment of the present invention further provides an apparatus for calligraphic beautification of handwritten characters.

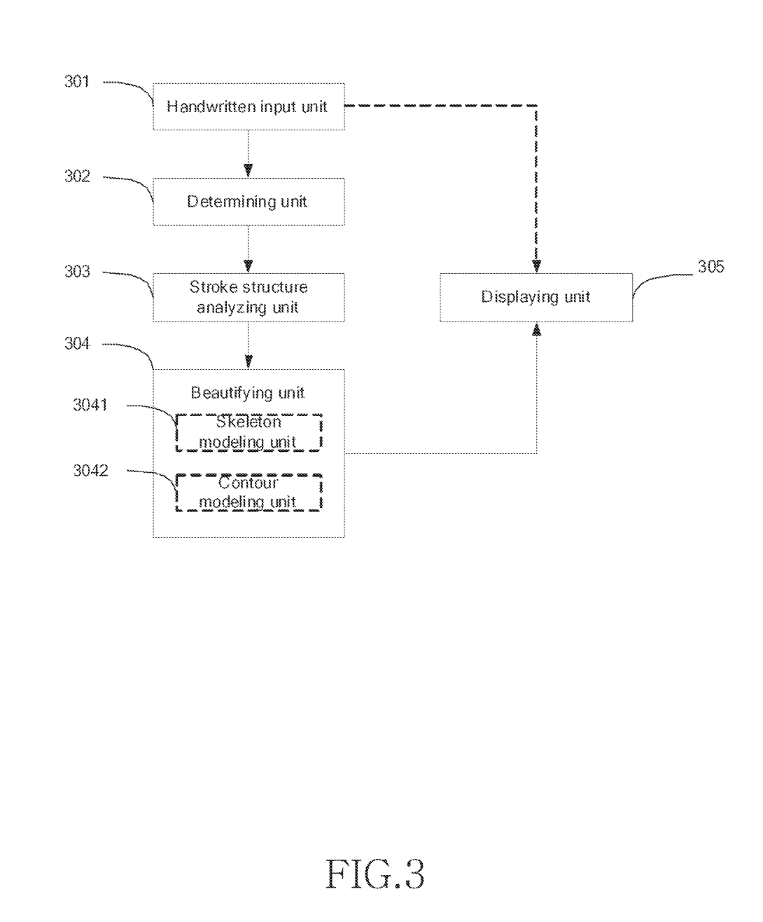

FIG. 3 is a schematic diagram illustrating a structure of an apparatus according to an exemplary embodiment of the present invention.

Referring to FIG. 3, the apparatus may include a handwriting input unit 301, a determining unit 302, a stroke structure analyzing unit 303, a beautifying unit 304, and a displaying unit 305. These units may be implemented by components that are entities related to the exemplary embodiments of the present invention. The components may be hardware or a combination of hardware and software. For example, the component may be, but is not limited to, a process operating on a processor, a processor, an object, an executable thread or program stored on a non-transitory computer readable medium, or a computer. For example, an application program running in a mobile terminal may be a component. In addition, the component may include one or more components. The units of the apparatus may be deployed by a distributed manner. For example, some units may be deployed at a server end and other units may be deployed at a terminal.

In particular, the handwriting input unit 301 may be adapted to collect handwriting data of the user's input in real-time. The handwriting data may refer to coordinates including X-axis coordinates and Y-axis coordinates where the user touches the inputting device, such as a touch screen, during the input, and may further include pressure information, or other similar information.

The determining unit 302 may be adapted to determine whether to start the beautification operation and to start the stroke structure analyzing unit 303 if it is determined to start the beautification operation. There may be various kinds of starting times, the details may be found in the exemplary embodiments described with respect to FIGS. 1 and 2 and will not be repeated herein below.

The stroke structure analyzing unit 303 may be adapted to determine the stroke structure information according to the collected handwriting data and start the beautifying unit 304. The stroke structure information may refer to a structure relationship between a stroke and other strokes. For example, the stroke structure information may include at least one of whether the stroke is an important stroke, whether the stroke has an adjacent stroke at the end of the stroke, and whether the stroke is in a surrounded structure.

The beautifying unit 304 may be adapted to perform the beautification operation according to a predefined handwriting beautification method corresponding to the stroke structure information and obtain a beautified result. The beautifying unit 304 may include a skeleton modeling unit 3041, which may be adapted to perform a skeleton modeling operation, e.g., translating, flexing, smoothing or rotating, to the collected handwriting data according to a method corresponding to the stroke structure information. The beautifying unit 304 may also include a contour modeling unit 3042, which may be adapted to perform a contour modeling operation according to a method corresponding to the stroke structure information based on the skeleton modeling. Additionally, the displaying unit 305 may be adapted to display the beautified result. However, the present invention is not limited thereto, and the apparatus may further include other units, such as a storage unit adapted to store the handwriting data and/or beautified result, a communicating unit adapted to implement communication of each unit, and any other similar and or suitable units used for the operation of electronic devices.

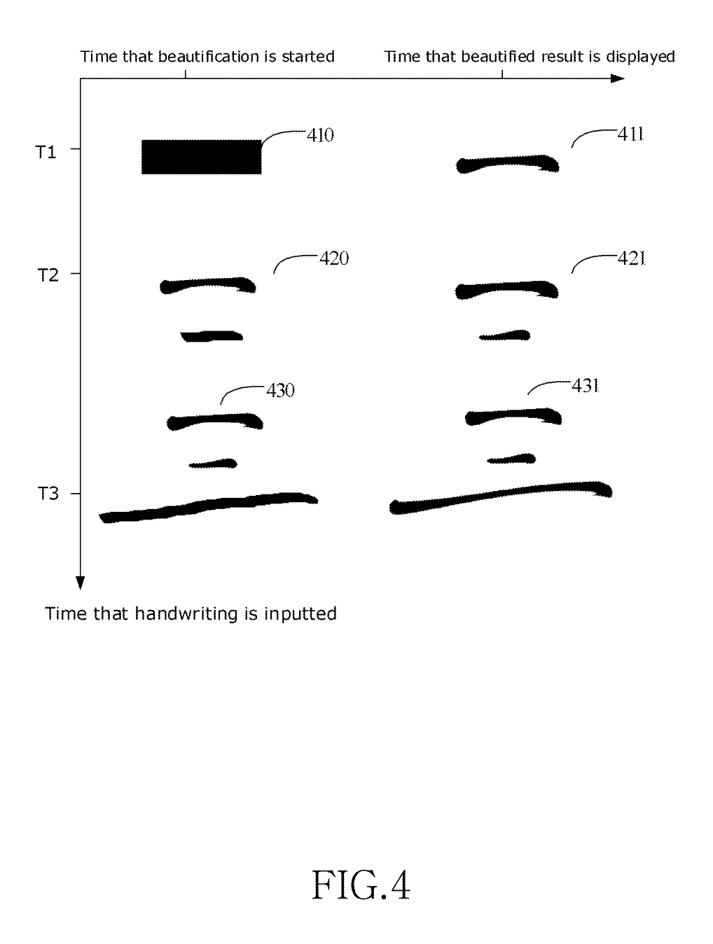

FIG. 4 is a schematic diagram illustrating a first example effect according to an exemplary embodiment of the present invention.

Referring to FIG. 4, a user inputs a Chinese character “San”, which is written as“ [symbol] ”. A first stroke is inputted at time T1, a second stroke is inputted at time T2 and a third stroke is inputted at time T3. At time T1 when the first stroke is inputted, the inputting device may collect the handwriting data and display a first trajectory 410 of the first stroke which is not beautified. After the methods disclosed in the exemplary embodiments of FIGS. 1 and 2 are utilized, the trajectory may be cleared up and a first beautified trajectory 411 may be displayed. It can be seen that, after being beautified, the trajectory 411 is relatively plump at end points. At time T2 when the second stroke is inputted, the inputting device displays a second trajectory 420. After beautification, the second trajectory 420 may be cleared up and a second beautified trajectory 421 may be displayed. Similarly, at time T3 when the third stroke is inputted, the inputting device displays a third trajectory 430. After beautification, the original trajectory may be cleared up and a third beautified trajectory 431 may be displayed. For the three strokes, the stroke structure information obtained by analyzing may be different. The second stroke may be determined as an unimportant stroke and the displayed beautified result of the second stroke may be different from those of the first and the third strokes.

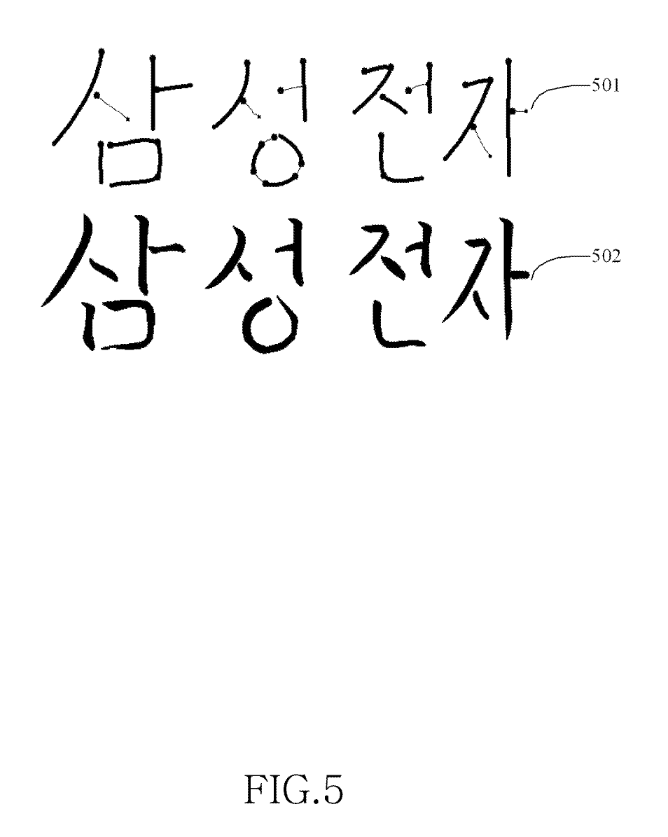

FIG. 5 is a schematic diagram illustrating a second example effect according to an exemplary embodiment of the present invention.

Referring to FIG. 5, section 501 shows several analyzed results corresponding to adjacent strokes, including a case where two ends of a stroke have no adjacent strokes, a case where the end point of the stroke has an adjacent stroke, a case where both the head point and the end point of the stroke have an adjacent stroke, and a case where neither the head point nor the end point of the stroke has an adjacent stroke. Section 502 shows a beautified result, wherein the beautification operation is started after the last stroke of each character is inputted. Herein, there is a similar vertical stroke in the character displayed as “ [symbol] ” and the character displayed as “ [symbol] ”. However, since the information as to “whether there is an adjacent stroke” may be different for the two displayed characters, they have different beautified results, which is more close to calligraphic habits of human beings.

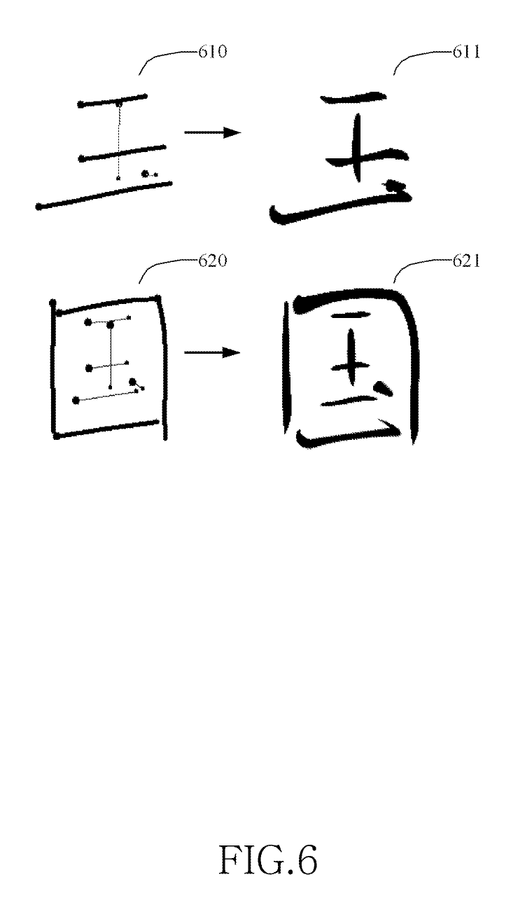

FIG. 6 is a schematic diagram illustrating a third example effect according to an exemplary embodiment of the present invention.

Referring to FIG. 6, surrounded stroke information and its beautified result during real-time beautification are illustrated. Section 610 shows a stroke analyzing result of Chinese character “Yu”, which is written as “ [symbol] ”. Section 611 shows a corresponding beautified result. Section 620 shows a stroke analyzing result of Chinese character “Guo”, which is written as “ [symbol] ” and section 621 shows a corresponding beautified result. Herein, although Chinese character “Guo”, which is written as “ [symbol] ” includes the handwriting data similar to that of Chinese character “Yu”, which is written as “ [symbol] ”, the information “whether the stroke is in a surrounded structure” is different with respect to each of the characters, and therefore the beautified results of them are different, which is more close to calligraphic habits of human beings.

During the beautification procedure of the present exemplary embodiments, the stroke structure information is fully utilized. Thus, different kinds of stroke structure information correspond to different beautification methods. The beautified result more accurately conforms to the user's habit and a user experience may be improved.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for calligraphic beautification of handwritten characters, the method comprising:
collecting handwriting data of a user's handwritten input in real-time;
determining whether a calligraphic beautification operation is to be started;
determining stroke structure information of a stroke according to the collected handwriting data if the calligraphic beautification operation is to be started;
continuing the collecting of the handwriting data if the calligraphic beautification operation is not to be started;
performing the calligraphic beautification operation according to a calligraphic beautification method corresponding to the stroke structure information; and
displaying a beautified result;
wherein the handwriting data comprises at least one of X-axis coordinates, Y-axis coordinates, and pressure information.

2. The method of claim 1, wherein the determining of the stroke structure information according to the collected handwriting data comprises at least one of:
obtaining stroke structure information of all strokes according to the collected handwriting data of all strokes, and updating the stroke structure information of all existing strokes;
obtaining stroke structure information of some of the strokes according to the collected handwriting data of all strokes, and updating the stroke structure information of some of the existing strokes; and
obtaining the stroke structure information of some of the strokes according to the collected handwriting data of some of the strokes, and updating the stroke structure information of some of the existing strokes.

3. The method of claim 1, wherein the determining of whether the calligraphic beautification operation is to be started comprises at least one of:
determining whether a current stroke is ended, and starting the calligraphic beautification operation if the current stroke is ended;
determining whether a number of handwriting points of a current stroke is larger than a predefined number threshold according to the collected handwriting data, and starting the beautification operation if the number of handwriting points of the current stroke is larger than the number threshold; and
determining whether a time interval between a current time and a time when the beautification operation is started last time is larger than a time threshold, and starting the beautification operation if the time interval is larger than the time threshold.

4. The method of claim 1, wherein the stroke structure information comprises information on at least one of whether the stroke is an important stroke, whether the stroke has an adjacent stroke at an end of the stroke, and whether the stroke is in a surrounding structure.

5. The method of claim 1, wherein the performing of the calligraphic beautification according to a calligraphic beautification method corresponding to the stroke structure information comprises:
performing a skeleton modeling corresponding to the collected handwriting data according to a method corresponding to the stroke structure information; and
performing a contour modeling according to a method corresponding to the stroke structure information based on the skeleton modeling.

6. The method of claim 5, wherein the performing of the skeleton modeling comprises:
interpolating or sub-sampling the collected handwriting data according to a device recognizing ratio;
performing a transformation operation comprising at least one of smoothing, rotating, expanding, contracting and translating to the collected handwriting data that has been interpolated or sub-sampled;
segmenting a skeleton of the stroke according to the handwriting data after the transformation operation; and
determining at least one of a skeleton type and position information.

7. The method of claim 5, wherein the performing of the contour modeling comprises:
calculating at least one of a tangent vector direction and a normal vector direction of the skeleton;
determining a basic contour surrounding the skeleton according to at least one of the tangent vector direction, the normal vector direction, the skeleton type and the position information, wherein the basic contour consists of spline curves and straight lines;
determining a head contour at an end of the skeleton, wherein the head contour consists of spline curves and straight lines;
determining a connection contour between skeletons, wherein the connection contour consists of spline curves and straight lines;
re-sorting the basic contour, the head contour and the connection contour of the stroke; and
obtaining a closed contour formed by the basic contour, the head contour and the connection contour end in end, wherein the closed contour consists of spline curves and straight lines.

8. The method of claim 7, wherein, if the stroke structure information shows that the stroke is the important stroke, then the closed contour consists of more than N1 spline curves, wherein N1 is an integer greater than 0, and wherein, if the stroke structure information shows that the stroke is an unimportant stroke, then the closed contour consists of less than M1 spline curves, wherein M1 is an integer greater than 0 and less than or equal to N1.

9. The method of claim 7, wherein, if the stroke structure information shows that the stroke has no adjacent stroke at the end of the stroke, then the closed contour consists of more than N2 spline curves, wherein N2 is an integer greater than 0, and
wherein, if the stroke structure information shows that the stroke has an adjacent stroke at the end of the stroke, then the closed contour consists of less than M2 spline curves, wherein M2 is an integer greater than 0 and less than or equal to N2.

10. The method of claim 7, wherein, if the stroke structure information shows that the stroke is not in the surrounding structure, then the closed contour consists of more than N3 spline curves, wherein N2 is an integer greater than 0, and
wherein, if the stroke structure information shows that the stroke is in a surrounded structure, then the closed contour consists of less than M3 spline curves, wherein M3 is an integer greater than 0 and less than or equal to N3.

11. An apparatus for calligraphic beautification of handwritten characters, the apparatus comprising:
a handwritten input unit for collecting handwriting data of a user's input in real-time;
a determining unit for determining whether to start the beautification operation;
a stroke structure analyzing unit that is started by the determining unit if it is determined to start the beautification operation, the stroke structure analyzing unit being for determining the stroke structure information according to the collected handwriting data;
a beautifying unit that is started by the stroke structure analyzing unit, the beautifying unit being for performing the beautification operation according to a predefined handwriting beautification method corresponding to the stroke structure information and for obtaining a beautified result; and
a displaying unit for displaying the beautified result;
The apparatus of claim 20, wherein the handwriting data comprises at least one of X-axis coordinates, Y-axis coordinates, and pressure information.

12. The apparatus of claim 11, wherein, when the stroke structure analyzing unit determines the stroke structure information, the stroke structure analyzing unit performs at least one of:
obtaining stroke structure information of all strokes according to the collected handwriting data of all strokes, and updating the stroke structure information of all existing strokes;
obtaining stroke structure information of some of the strokes according to the collected handwriting data of all strokes, and updating the stroke structure information of some of the existing strokes; and
obtaining the stroke structure information of some of the strokes according to the collected handwriting data of some of the strokes, and updating the stroke structure information of some of the existing strokes.

13. The apparatus of claim 11, wherein the stroke structure information comprises information on at least one of whether the stroke is an important stroke, whether the stroke has an adjacent stroke at an end of the stroke, and whether the stroke is in a surrounding structure.

14. The apparatus of claim 11, wherein the beautifying unit comprises:
a skeleton modeling unit for performing a skeleton modeling corresponding to the handwriting data collected according to a method corresponding to the stroke structure information; and
a contour modeling unit for performing a contour modeling based on the skeleton modeling according to a method corresponding to the stroke structure information.

15. The apparatus of claim 14, wherein the skeleton modeling unit is for interpolating or sub-sampling the collected handwriting data according to a device recognizing ratio, for performing a transformation operation comprising at least one of smoothing, rotating, expanding, contracting and translating to the handwriting data that has been interpolated or sub-sampled, for segmenting a skeleton of the stroke according to the handwriting data after the transformation operation, and for determining at least one of a skeleton type and position information.

16. The apparatus of claim 14, wherein the contour modeling unit is for calculating at least one of a tangent vector direction and a normal vector direction of the skeleton, for determining a basic contour surrounding the skeleton according to at least one of the tangent vector direction, the normal vector direction, the skeleton type and the position information, wherein the basic contour consists of spline curves and straight lines, for determining a head contour at an end of the skeleton, wherein the head contour consists of spline curves and straight lines, for determining a connection contour between skeletons, wherein the connection contour consists of spline curves and straight lines, for re-sorting the basic contour, the head contour and the connection contour of the stroke, and for obtaining a closed contour formed by the basic contour, the head contour and the connection contour end in end, wherein the closed contour consists of spline curves and straight lines.

17. The apparatus of claim 16, wherein, if the stroke structure information shows that the stroke is the important stroke, then the closed contour consists of more than N1 spline curves, wherein N1 is an integer greater than 0, and wherein, if the stroke structure information shows that the stroke is an unimportant stroke, then the closed contour consists of less than M1 spline curves, wherein M1 is an integer greater than 0 and less than or equal to N1.

18. The apparatus of claim 16, wherein, if the stroke structure information shows that the stroke has no adjacent stroke at the end of the stroke, then the closed contour consists of more than N2 spline curves, wherein N2 is an integer greater than 0, and
wherein, if the stroke structure information shows that the stroke has the adjacent stroke at the end of the stroke, then the closed contour consists of less than M2 spline curves, wherein M2 is an integer greater than 0 and less than or equal to N2.

19. The apparatus of claim 16, wherein, if the stroke structure information shows that the stroke is not in the surrounding structure, then the closed contour consists of more than N3 spline curves, wherein N2 is an integer greater than 0, and
wherein, if the stroke structure information shows that the stroke is in the surrounding structure, then the closed contour consists of less than M3 spline curves, wherein M3 is an integer greater than 0 and less than or equal to N3.

20. The apparatus of claim 11, further comprising a storage unit for storing the handwriting data of the user's handwritten input.
